(19) United States
(12) Patent Application Publication
(10) Pub. No.: US 2013/0029667 A1
(43) Pub. Date: Jan. 31, 2013

(54) IDENTIFICATION METHOD AND SWITCHING METHOD OF FEMTOCELL AND FEMTOCELL SYSTEM

(71) Applicant: Ling Zhu, Su Zhou City (CN)

(72) Inventor: Ling Zhu, Su Zhou City (CN)

(73) Assignee: SERNET (SUZHOU) TECHNOLOGIES CORPORATION, JIANGSU (CN)

(21) Appl. No.: 13/555,597

(22) Filed: Jul. 23, 2012

(30) Foreign Application Priority Data
Jul. 26, 2011 (CN) 201110209921.5

(51) Int. Cl. H04W 36/08

(52) U.S. Cl. 455/438

(57) ABSTRACT

A switching method of a femtocell includes steps of: a) detecting an air message, and determining, according to signal strength, a base station corresponding to a broadcast message in the detected air message as a standby base station; b) determining whether the standby base station is the femtocell according to a specific identification sequence and a pilot channel output power value in the broadcast message of the standby base station; according to step (b), determining a first standby base station corresponding to a first broadcast message as a base station of a first type; according to step (b), determining a second standby base station corresponding to a second broadcast message as a base station of a second type; and with respect to the first standby base station and the second standby base station, prioritizing the femtocell to switch to the first standby base station for service handover.

This application claims the benefit of People's Republic of China application Serial No. 201110209921.5, filed Jul. 26, 2011, the subject matter of which is incorporated herein by reference.

### BACKGROUND

1. Field of the Invention

The invention relates in general to a method of a femtocell, and more particularly to an identification method and a switching method of a femtocell and a femtocell system.

2. Description of the Related Art

In a communication system, e.g., a 3G network, a femtocell connects to user equipments of users within home or small range via an air interface, and connects the user equipments to a network of an operator network via a broadband network to achieve mobile data off-loading. Thus, indoor communication quality is improved while audio and data services can be provided in reduced cost.

Femtocells can be categorized into home node-B (HNB) and home evolved node-B (HeNB). A femtocell is disposed in a home or a in a business to provide wireless coverage and access service for user equipments.

In the current 3G standard, methods adopted for a femtocell for identifying another femtocell or other types of base stations are not clearly defined. As a result, when switching between different types of cells, loading on a macrocell network cannot be reduced.

### SUMMARY OF THE INVENTION

The invention is directed to an identification method and a switching method of a femtocell and a femtocell system.

According to an aspect of the present invention, an identification method of a femtocell for a femtocell to identify a type of another base station is provided. The method includes steps of: detecting an air message, and determining, according to signal strength, a base station corresponding to a broadcast message in the detected air message as a standby base station; determining whether a specific identification sequence in the broadcast message of the standby base station includes a predetermined femtocell identifier; and determining whether the specific identification sequence further includes a grouping code corresponding to the femtocell. When the specific identification sequence includes the predetermined femtocell identifier, the femtocell determines the standby base station is a femtocell.

According to another aspect of the present invention, a switching method of a femtocell applied to a femtocell is provided. The method includes steps of: a) detecting an air message, and determining, according to signal strength, a base station corresponding to a broadcast message in the detected air message as a standby base station; b) determining whether the standby base station is a femtocell according to a specific identification sequence and a pilot channel output power value in the broadcast message of the standby base station; according to step (b), determining a first standby base station corresponding to a first broadcast message as a base station of a first type; according to step (b), determining a second standby base station corresponding to a second broadcast message as a base station of a second type; and with respect to the first standby base station and the second standby base station, prioritizing the femtocell to switch to the first standby base station for service handover.

According to yet another aspect of the present invention, a femtocell system is provided. The femtocell system includes a mobile communication unit and a processing unit. The mobile communication unit detects an air message. The processing unit, coupled to the mobile communication unit to control the mobile communication unit, determines, according to signal strength, a base station corresponding to a broadcast message in the detected air message as a standby base station, and determines whether the standby base station is a femtocell according to a specific identification sequence and a pilot channel output power value in the broadcast message of the standby base station. The processing unit further determines a first standby base station corresponding to a first broadcast message as a base station of a first type according to a specific identification sequence and a pilot channel output power value in the first broadcast message, and determines a second standby base station corresponding to a second broadcast message as a base station of a second type according to a specific identification sequence and a pilot channel output power value in the second broadcast message. The processing unit further controls and prioritizes the femtocell system to switch to the first standby base station for service handover.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a diagram illustrating a femtocell identifying other base stations according to one embodiment.

FIG. 2 is a flowchart of an identification method of a femtocell according to one embodiment.

FIG. 3 is a flowchart of a switching method of a femtocell according to one embodiment.

FIG. 4 is a diagram of a femtocell system according to one embodiment.

### DETAILED DESCRIPTION OF THE INVENTION

An identification method and a switching method of a femtocell and a femtocell system according to embodiments of the present invention shall be described below. In the identification method according to one embodiment, the femtocell identifies a type of another base station according to a specific identification sequence and a pilot channel output power value in a broadcast message from another base station. In the switching method according to another embodiment, after a femtocell identifies the type of another base station, switching for service handover is implemented in different priority sequences according to the type of the base station. A femtocell system capable of identifying the type of a base station and switching between other types of base stations is further provided according to yet another embodiment.

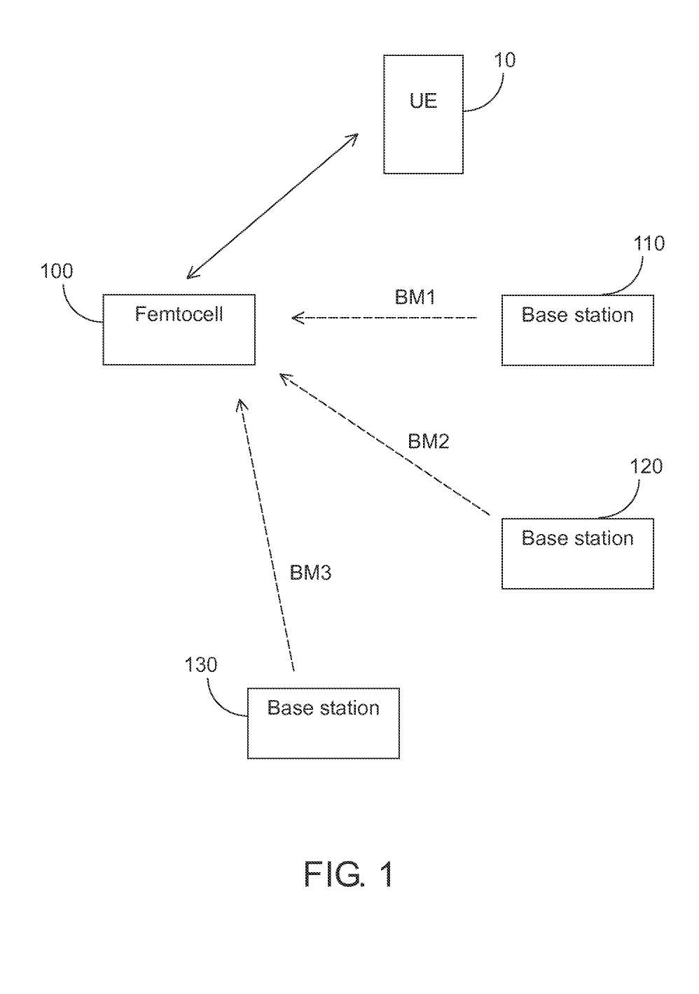

Referring to FIG. 1, a femtocell 100, e.g., a home node-B (HNB) or a home evolved node-B (HeNB), is disposed in a home, a school, a business unit or an enterprise, to provide wireless coverage and access service of a user equipment (UE) 10. As the user equipment 10 gets farther away from the femtocell 100 or as signal strength weakens, services provided by the femtocell 100 need to be switched over (i.e., service handover) to another base station, e.g., a base station 110, 120 or 130.

Under practical situations, at indoors or within a home or an enterprise, the base station located near or other than the femtocell 100 may be a femtocell, or a non-femtocell such as an indoor distribution system (e.g., a picocell having a lower transmitting frequency than a macrocell) or a macrocell.

Another possible situation is that, multiple femtocells divided into different groups are installed in an enterprise or a business unit, or femtocells of different manufacturers or services providers are utilized. Alternatively, femtocells of a same manufacturer or service provider may be employed by two close-by organizations or enterprises, in a way that femtocells utilized by one organization ought to be distinguished from those of another organization.

In this regard, in one embodiment, a broadcast message generally transmitted from a base station is utilized to carry a predetermined femtocell identifier for identifying whether the base station is a femtocell. For example, under 3G Universal Mobile Telecommunication System (UMTS) specifications, a distinguishing code is defined in a specific identification sequence (e.g., one or multiple fields, bits or locations) in the broadcast message transmitted by the base station to record a predetermined femtocell identifier. For example, in the UMTS Radio Resource Control (RRC) protocol, an information element (IE) “Cell Identity” in SIB 3/4, i.e., system information block (SIB) type 3 or type 4, carried in system broadcasting information, can be utilized for defining a position for the above distinguishing code. For example, in the cell identity, the first 12 bits are for an RNC identifier and the last 16 bits are for “Cell ID”. Thus, for a same type of femtocells broadcasting in a small area, the femtocells may add a specific identification sequence to “Cell ID” and define certain bit(s) in the specific identification sequence as a distinguishing code. When the femtocell 100 performs searching, the femtocell 100 may identify whether a base station is a femtocell according to the distinguishing code. In this way, different femtocell manufacturers or service providers may also define respective predetermined femtocell identifiers carried in the specific identification sequence for distinguishing the femtocells from different manufacturers. Further, the femtocell identifier may also serve for other purposes rather than the example above.

In an alternative embodiment, a portion of the bits in the specific identification sequence may also be defined to represent a grouping code in addition to the distinguishing code. Taking the above “Cell ID” for example, a portion of the bits (e.g., 4 bits) in the specific identification sequence are defined as a distinguishing code while another portion (e.g., 10 bits) is defined as a grouping code. Further, other codes may also be defined in the specific identification sequence for other identification purposes in addition to the example above.

In one embodiment, it is determined whether a base station is a femtocell according to a pilot channel output power value obtained from a broadcast message transmitted from the base station. Regarding this, it is noted that total transmit power of a femtocell is smaller than that of other base stations such as a macrocell or an indoor distribution system. Further, transmit power of a pilot channel of a femtocell is substantially a fixed value. Thus, a base station is determined as a femtocell when the transmit power of the pilot channel is determined as not greater than a threshold. For example, in the UMTS RRC protocol, the common pilot channel (PICH) power offset of SIB type 5 or type 6 (i.e., SIB 5/6) carried in the system broadcast information can be employed to serve as a parameter for determining whether a base station is a femtocell. In WDCMA, the SIB 5/6 PICH power offset may be converted into the power value of a primary common pilot channel. In TD-SCDMA, the SIB 5/6 PICH power offset may be converted into the power value of a primary common control physical channel (PCCPCH). According to common definitions of a femtocell, a total transmit power Pₘₐₓ is usually 20 dBm. In this way, a base station having a pilot channel transmit power not greater than a threshold Pₘₐₓ−P_{offset} can be determined to be a femtocell. For example, the offset P_{offset} can be set to an empirical value of 10 dB for Wideband Code Division Multiple Access (WCDMA) and 5 dB for Time Division Synchronous Code Division Multiple Access (TD-SCDMA). It should be noted that, when implementing a femtocell, the above threshold is adjustable, and has a self-definable initial value, e.g., defined with reference to service provider's data.

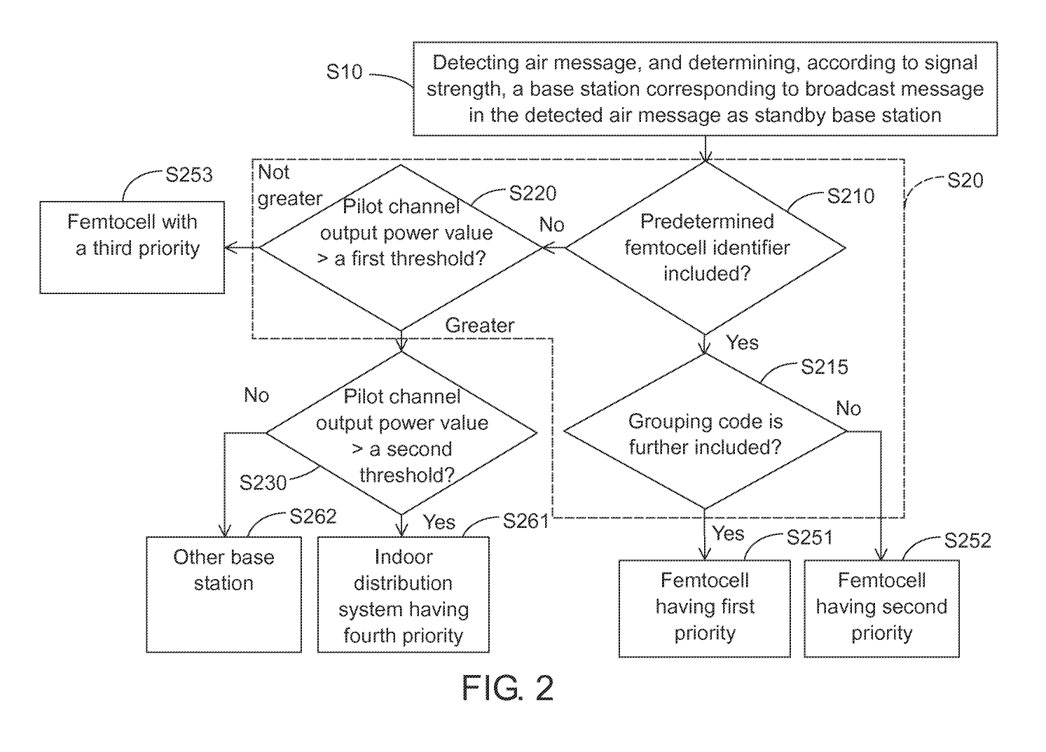

As described above, the femtocell according to one embodiment is capable of distinguishing different base stations according to the specific identification sequence and the pilot channel output power value. FIG. 2 shows a flowchart of an identification method of a femtocell according to one embodiment. The method is applicable to a femtocell or system to identify a type of another base station (e.g., the base station 110, 120 or 130).

In step S10, an air message is detected, e.g., not from the femtocell or may be from other base station, and a base station corresponding to a broadcast message in the detected air message is determined, according to signal strength, as a standby base station. For example, the femtocell 100 detects an air message from base stations surrounding or near the femtocell 100. In step S10, for example, an approach for determining whether a base station is a standby base station is determining whether the signal strength of a broadcast message in the detected air message satisfies a condition. A base station corresponding to the broadcast message satisfying the condition is determined as the standby base station. For example, the above condition is whether the signal strength is less than a threshold, or other condition such as regarding one or multiple signal strength parameters as criteria. The determination of signal strength may be based on a received signal code power (RSCP) value. For example, it is determined whether the value of RSCP is greater than a threshold, e.g., −85 dBm. The following provides further determination with respect to the standby base station.

In continuation of the identification method of the femtocell, in step S20, it is determined whether the type of the standby base station is femtocell, based on the specific identification sequence and the pilot channel output value in the broadcast message (e.g., broadcast message BM1, BM2 or BM3 as illustrated in FIG. 1) of the standby base station. Referring to FIG. 2, in one embodiment, step S20 includes step S210. In step S210, it is determined whether a specific identification sequence in the broadcast message of the standby base station includes a predetermined femtocell identifier. If the specific identification sequence includes the predetermined femtocell identifier, the femtocell 100 determines the standby base station corresponding to the broadcast message to be a femtocell.

In one embodiment, step S20 includes step S220. In step S220, it is determined whether a pilot channel output power value obtained from the broadcast message is not greater than a first threshold. For example, the threshold is the foregoing value of Pₘₐₓ−P_{offset} corresponding to the femtocell. When the pilot channel output power value is not greater than the first threshold, it is determined that the standby base station corresponding to the pilot channel output power value is a femtocell. As shown in step S253, the standby base station is a femtocell having a third priority. When the pilot channel output power value is greater than the first threshold, the standby base station corresponding to the pilot channel output power value is not a femtocell.

In one embodiment, the femtocell 100 categorizes the identified standby base station to facilitate a prioritization process. For example, the femtocell 100 further introduces priority identification for service handover between base stations. Referring to FIG. 2, in one embodiment, step S20 further includes step S215, in which it is determined whether the specific identification sequence in the broadcast message (e.g., BM1) includes a grouping code corresponding to the femtocell 100. For example, for femtocells of a same type or a same manufacturer, a predetermined grouping code (e.g., a bit or any other identifier) is set for distinguishing purposes. When the above specific identification sequence includes a grouping code corresponding to the femtocell 100, the base station (e.g., 110) corresponding to the broadcast message (e.g., BM1) is a femtocell having a first priority, as shown in step S251. As shown in step S252, when the specific identification sequence in the broadcast message (e.g., BM2) does not include the grouping code, the femtocell 100 determines that the base station (e.g., 120) corresponding to the broadcast message (e.g., BM2) is a femtocell having a second priority. In one embodiment, with respect to the femtocell having the first priority and the femtocell having the second priority, the femtocell 100 is prioritized to switch to the femtocell having the first priority for service handover. It should be noted that, the identification approach is not limited to the example above, and other priority sequences and other handover priority sequences may be designed based on the spirit of the embodiments above.

In one embodiment, step S220 is performed when it is determined in step S210 that the specific identification sequence does not include the predetermined femtocell identifier. In step 220, when it is determined that a pilot channel output power value obtained from a broadcast message is not greater than the above first threshold, a standby base station corresponding to the pilot channel output power value is a femtocell having a third priority. In one embodiment, with respect to a standby base station (e.g., a femtocell having a second priority or a third priority) corresponding to the broadcast message including the predetermined femtocell identifier and a femtocell having a third priority, the femtocell 100 is prioritized to switch to the femtocell corresponding to the broadcast message including the predetermined femtocell identifier for service handover.

As observed from the above embodiments, step S20 is capable of identifying whether a base station other than the femtocell 100 is a femtocell. Further, steps S210, S220 and S215 may be performed in a different order. For example, step S220 is performed before step S210 to identify the type of different femtocells or to prioritize the identified femtocells. Hence, step S20 may be implemented through several approaches rather being limited to the embodiments above.

In other embodiments, when it is determined that a standby base station is a non-femtocell in step S220, an approach similar to step S220 may be performed to categorize the non-femtocell as an indoor distribution system or a macrocell, for example. For example, in step S230, it is determined whether the pilot channel output power value of the non-femtocell is not greater than a second threshold, which is greater than the first threshold. For example, the second threshold is set to equal to Pₘₐₓ−P_{offset}, wherein Pₘₐₓ corresponds to total transmit power of an indoor distribution system or a picocell, such as 27, 28 or 30 dBm. When the pilot channel output power value is not greater than the second threshold, the femtocell 100 determines the standby base station corresponding to the pilot channel output power value is an indoor distribution system, and the standby base station is an indoor distribution system having a fourth priority, as shown in step S261. In one embodiment, with respect to a femtocell having a third priority (e.g., 110 or 120) and an indoor distribution system (e.g., 130), the femtocell 100 is prioritized to switch to the femtocell having the third priority for service handover. As shown in step S262, when the pilot channel output power value is greater than the second threshold, the femtocell 100 determines that the base station corresponding to the pilot channel output power value is a macrocell or another type of base station, and the standby base station is another base station. In one embodiment, with respect to an indoor distribution system and another base station, the femtocell 100 is prioritized to switch to the indoor distribution system for service handover.

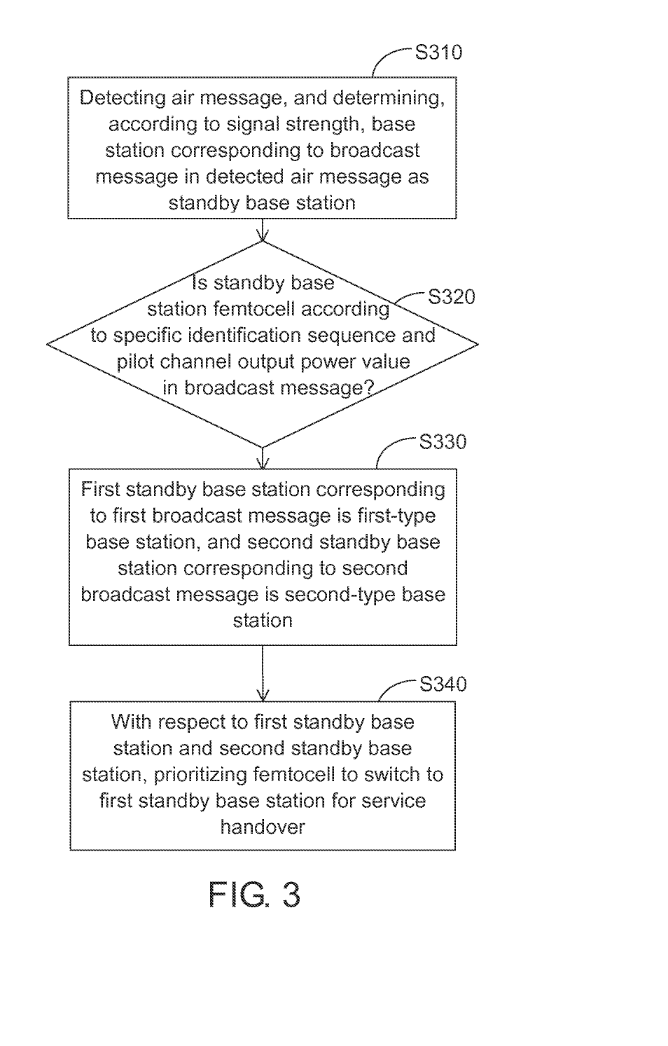

FIG. 3 shows a flowchart of a switching method of a femtocell according to one embodiment. The method is applicable to a femtocell or femtocell system (to be referred to as a femtocell), and includes the following steps. In step S310, an air message is detected, e.g., not from the femtocell (e.g., 100) or may be from other base station or surrounding the femtocell, and it is determined, according to signal strength, that a base station corresponding to a broadcast message in the detected air message is a standby base station. The approach to the determination of the standby base station may be referred to the previously described embodiments. In step S320, according to a specific identification sequence and a pilot channel output power value in a broadcast message of the standby base station determined in step S310, it is determined whether the standby base station is a femtocell, as described in FIG. 2 and related different embodiments above. In step S330, it is determined that a first standby base station (e.g., 110) corresponding to a first broadcast message (e.g., BM1) is a base station of a first type according to step S320, and it is determined that a second standby base station (e.g., 120) corresponding to a second broadcast message (e.g., BM2) is a base station of a second type according to step S320. In step S340, with respect to the first standby base station and the second standby base station, the femtocell 100 is prioritized to switch to the first standby base station for service handover.

Service handover is proceeded in compliance with of the requirements of communication standards (such as 3G) supported by the femtocell. That is, the handover can be performed according to the priority sequences in the embodiments, according to whether received signal code power (RSCP) is within a reasonable range for the communication standard.

In one embodiment, the first-type base station is a femtocell, and the first broadcast message includes a predetermined femtocell identifier, as exemplified above, and a grouping code corresponding to the femtocell 100. The second-type base station is a femtocell, and the second broadcast message includes the predetermined femtocell identifier but not the grouping code corresponding to the femtocell 100. Another possible situation is that, the second broadcast message of the second standby base station does not include the predetermined femtocell identifier. Yet another possible situation is that, the second-type base station is a femtocell, and the pilot channel output power value in the second broadcast message is not greater than the first threshold, e.g., Pₘₐₓ−P_{offset} corresponding to the femtocell as exemplified above. Yet another possible situation is that, the second-type base station is a non-femtocell, and the pilot channel output power value in the second broadcast message is greater than the first threshold.

In another embodiment, the first-type base station is a femtocell, and the first broadcast message includes the predetermined femtocell identifier but not the grouping code corresponding to the femtocell 100. The second broadcast message of the second standby base station does not include the predetermined femtocell identifier. Regarding this embodiment, a possible situation is that, the second-type base station is a femtocell, and the pilot channel output power value in the second broadcast message is not greater than the first threshold. Another possible situation is that, the second-type base station is a non-femtocell, and the pilot channel output power value in the second broadcast message is greater than the first threshold.

In another embodiment, the first standby base station is a femtocell, and the first broadcast message does not include the predetermined femtocell identifier and the pilot channel output power value in the first broadcast message is not greater than the first threshold. In this case, a possible situation is that, the second-type base station is a non-femtocell, and the pilot channel output power value in the second broadcast message is greater than the first threshold.

In yet another embodiment, the first-type base station is a non-femtocell, and the pilot channel output power value in the first broadcast message is greater than the first threshold but smaller than the second threshold. The second-type base station is a non-femtocell, and the pilot channel output power value in the second broadcast message is greater than the first threshold and is also greater than the second threshold.

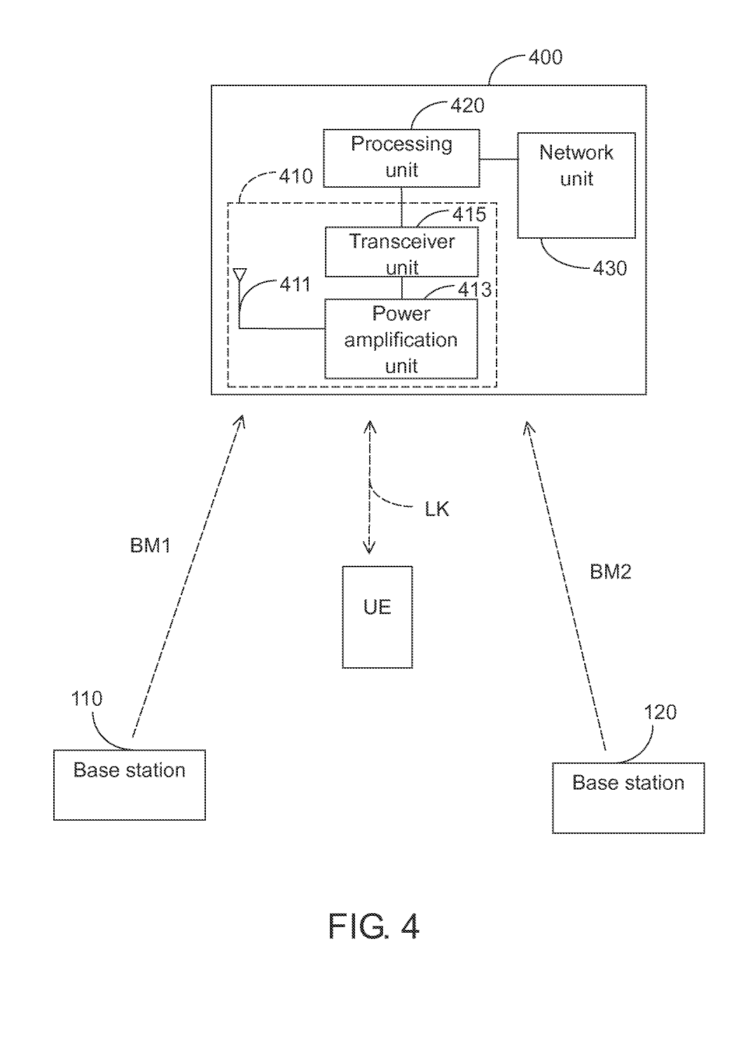

FIG. 4 shows a block diagram of a femtocell system according to one embodiment of the present invention. A femtocell system 400 includes a mobile communication unit 410 and a processing unit 420. The femtocell system 400 provides wireless coverage for access service for a user equipment in form of an electronic device such as a smart phone, a tablet computer or a mobile device to respectively establish a wireless link LK offering different services.

The mobile communication unit 410 may be regarded as an analog front end for wireless transceiving. The mobile communication unit 410 includes an antenna 411, a power amplification unit 413 and a transceiver unit 415. The antenna 411 is coupled to the power amplification unit 413, and the transceiver unit 415 is coupled to the power amplification unit 413. In other embodiments, the mobile communication unit 410 may be implemented in compliant with at least one or more communication modes (such as 2G, 3G or 4G) so as to modify the architecture or the number of components. Thus, the mobile communication unit 410 is not limited to the embodiment as shown in FIG. 4. For example, a 3G femtocell H(e)NB such as a home node-B or a home evolved node-B needs to monitor a UMTS channel and to detect nearby base stations as well as to detect 2G channels, so that when a user equipment leaves a femtocell zone of the femtocell system 400, the user equipment can switch to an appropriate network such as a network of another base station, such as base station 110 or 120. In this example, the mobile communication unit 410 may include analog front end circuitry for UMTS and 2G.

The mobile communication unit 410 detects an air message (e.g., BM1 or BM2), which may be from a base station other than the femtocell system 400.

The processing unit 420, coupled to the mobile communication unit 410, controls the mobile communication unit 410 to operate in at least one mobile communication mode (e.g., 2G, 3G, or 4G mode).

The processing unit 420 determines whether signal strength of a broadcast message in the air message detected by the mobile communication unit 410 satisfies a standby condition. A base station corresponding to the broadcast message satisfying the condition is a standby base station. According to a specific identification sequence and a pilot channel output power value in the broadcast message of the standby base station, it is determined whether the standby base station is a femtocell.

According to a predetermined identification sequence and a pilot channel output power value in a first broadcast message (e.g., BM1), the processing unit 420 determines that a first standby base station (e.g., 110) corresponding to the first broadcast message is a first-type base station. According to a predetermined identification sequence and a pilot channel output power value in a second broadcast message (e.g., BM2), the processing unit 420 determines that a second standby base station (e.g., 120) corresponding to the second broadcast message is a second-type base station. For service handover, the processing unit 420 controls and prioritizes the femtocell system 400 to switch to the first standby base station.

The priority sequence for service handover may be implemented with reference to descriptions of the foregoing embodiments. Therefore, the femtocell system 400 is able to implement the identification method and the switching method according to the foregoing embodiments by ways of software, hardware or firmware.

For example, the processing unit 420 is implemented by a microcontroller (MCU), a digital signal processor (DSP), a field-programmable gate array (FPGA), an application specific integrated circuit (ASIC) or a system-on-chip (SoC).

Further, the processing unit 420 may implement a femtocell layer 1 (FL1) and a femtocell radio resource management (FRRM) as a femtocell entity that may be regarded as a femtocell system. In another embodiment, the FRRM can be implemented as an independent device, such as using a processing unit of a femtocell gateway, and the FL1 can be implemented by using a processing unit of the femtocell, such that the two (i.e., the femtocell gateway and femtocell) together can be regarded as a femtocell system. The FL1 unit represents a logic unit or a hardware unit for realizing operations for linking between a femtocell and a user equipment, by using such as a 3G mobile communication layer 1 Uu air interface. The FRRM unit represents a logic unit or a hardware unit for performing operations associated with radio resource management between the FL1 unit and a core network OAM (e.g., a network of a service provider (or operator)). In one embodiment, the FL1 and the FRRM can be combined to form a device of a femtocell entity. In another embodiment, the FRRM can be an independent device.

In another embodiment, to connect a user equipment to a service provider's network via a broadband network, the femtocell system 400 further includes a network unit 430 for providing an interface between the femtocell system 400 and the broadband network. In an alternative embodiment, the network unit 430 provides an interface between the femtocell system 400 and a femtocell gateway. Hence, the femtocell system 400 may be implemented to modify the architecture or the number of components or be implemented through other approaches, according to the design requirement, and is not limited to the examples above.

Further, in another embodiment, 3G protocols such as WCDMA or TD-SCDMA or even 4G may be implemented by the above embodiments according to actual requirements.

Therefore, with description of the above embodiments, the identification method and the switching method of a femtocell and the femtocell system disclosed are capable of identifying a femtocell from other femtocells or base stations. In certain embodiments, not only femtocells of a same type or different groups are further identified but also switching priority sequences between femtocells are implemented for service handover, so as to provide flexibility in the deployment and applications of the femtocells, thus embodying a self-optimizing network (SON). Thus, when switching between femtocells for service handover, the data offloading on a macrocell network can be achieved appropriately.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An identification method of a femtocell, applied to a femtocell for identifying a type of another base station, the method comprising:
detecting an air message, and determining, according to signal strength, a base station corresponding to a broadcast message in the detected air message as a standby base station;
determining whether a specific identification sequence in the broadcast message of the standby base station includes a predetermined femtocell identifier; and
determining whether the specific identification sequence further includes a grouping code corresponding to the femtocell;
wherein the femtocell determines that the standby base station is a femtocell when the specific identification sequence includes the predetermined femtocell identifier.

2. The identification method according to claim 1, wherein when the specific identification sequence includes the predetermined femtocell identifier and the grouping code, the standby base station is a femtocell having a first priority.

3. The identification method according to claim 2, wherein when the specific identification sequence includes the predetermined femtocell identifier but not the grouping code, the standby base station is a femtocell having a second priority.

4. The identification method according to claim 3, wherein with respect to a standby base station having the first priority and a base station having the second priority, the femtocell is prioritized to switch to the standby base station having the first priority for service handover.

5. The identification method according to claim 1, further comprising:
determining whether a pilot channel output power value obtained from the broadcast message of the standby base station is not greater than a first threshold;
wherein when the pilot channel output power value is not greater than the first threshold, the standby base station corresponding to the pilot channel output power value is a femtocell having a third priority.

6. The identification method according to claim 5, wherein when the specific identification sequence does not include the predetermined femtocell identifier, the step of determining whether the pilot channel output power value obtained from the broadcast message is not greater than the first threshold is performed.

7. The identification method according to claim 5, wherein with respect to a base station corresponding to the broadcast message including the predetermined femtocell identifier and a standby base station having the third priority, the femtocell is prioritized to switch to the standby base station corresponding to the broadcast message including the predetermined femtocell identifier for service handover.

8. The identification method according to claim 5, further comprising:
determining whether the pilot channel output power value is not greater than a second threshold when the pilot channel output power value is greater than the first threshold;
wherein when the pilot channel output power value is not greater than the second threshold, the standby base station corresponding to the pilot channel output power value is an indoor distribution system.

9. The identification method according to claim 8, wherein with respect to a standby base station having the third priority and the indoor distribution system, the femtocell is prioritized to switch to the standby base station having the third priority for service handover.

10. The identification method according to claim 8, wherein when the pilot channel output power value is greater than the second threshold, the standby base station corresponding to the pilot channel output power value is a macrocell.

11. The identification method according to claim 10, wherein with respect to a standby base station of the indoor distribution system and a standby macrocell, the femtocell is prioritized to switch to the base station of the indoor distribution system for service handover.

12. The identification method according to claim 1, wherein a base station corresponding to the broadcast message having the signal strength satisfying a condition is a standby base station, and the condition includes whether the signal strength is greater than a threshold.

13. A switching method of a femtocell, comprising:
a) detecting an air message, and determining, according to signal strength, a base station corresponding to a broadcast message in the detected air message as a standby base station;
b) determining whether the standby base station is a type of femtocell according to a specific identification sequence and a pilot channel output power value in the broadcast message of the standby base station;
c) according to step (b), determining that a first standby base station corresponding to a first broadcast message is a base station of a first type;
d) according to step (b), determining that a second standby base station corresponding to a second broadcast message is a base station of a second type; and
e) with respect to the first standby base station and the second standby base station, prioritizing the femtocell to switch to the first standby base station for service handover.

14. The switching method according to claim 13, wherein the first type is femtocell, and the first broadcast message includes the predetermined femtocell identifier and a grouping code corresponding to the femtocell.

15. The switching method according to claim 14, wherein the second type is femtocell, and the second broadcast message includes the predetermined femtocell identifier but not the grouping code corresponding to the femtocell.

16. The switching method according to claim 14, wherein the second standby base station does not include the predetermined femtocell identifier.

17. The switching method according to claim 16, wherein the second type is femtocell, and the pilot channel output power value in the second broadcast message is not greater than a first threshold.

18. The switching method according to claim 16, wherein the second type is non-femtocell, and the pilot channel output power value in the second broadcast message is not greater than a first threshold.

19. The switching method according to claim 13, wherein the first type is femtocell, and the first broadcast message includes the predetermined femtocell identifier but not a grouping code corresponding to the femtocell.

20. The switching method according to claim 19, wherein the second broadcast message of the second standby base station does not include the predetermined femtocell identifier.

21. The switching method according to claim 20, wherein the second type is femtocell, and the pilot channel output power value in the second broadcast message is not greater than a first threshold.

22. The switching method according to claim 20, wherein the second type is non-femtocell, and the pilot channel output power value in the second broadcast message is greater than a first threshold.

23. The switching method according to claim 13, wherein the first standby base station is a femtocell, and the first broadcast message does not include the predetermined femtocell identifier and the pilot channel output power value in the first broadcast message is not greater than a first threshold.

24. The switching method according to claim 23, wherein the second type is non-femtocell, and the pilot channel output power value in the second broadcast message is greater than the first threshold.

25. The switching method according to claim 13, wherein the first type is non-femtocell, and the pilot channel output power value in the first broadcast message is greater than a first threshold and smaller than a second threshold.

26. The switching method according to claim 25, wherein the second type is non-femtocell, and the pilot channel output power value in the second broadcast message is greater than the first threshold and greater than the second threshold.

27. The switching method according to claim 13, wherein a base station corresponding to the broadcast message having the signal strength satisfying a condition is a standby base station, and the condition includes whether the signal strength is greater than a threshold.

28. A femtocell system, comprising:
a mobile communication unit, for detecting an air message; and
a processing unit, coupled to the mobile communication unit to control the mobile communication unit, for determining a base station corresponding to a broadcast message in the detected air message as a standby base station according to signal strength, and determining whether the standby base station is a femtocell according to a specific identification sequence and a pilot channel output power value in the broadcast message of the standby base station;
wherein the processing unit determines that a first standby base station corresponding to a first broadcast message is a base station of a first type according to a specific identification sequence and a pilot channel output power value in the first broadcast message, determines that a second standby base station corresponding to a second broadcast message is a base station of a second type according to a specific identification sequence and a pilot channel output power value in the second broadcast message, and controls and prioritizes the femtocell system to switch to the first standby base station for service handover.

29. The femtocell system according to claim 28, wherein a base station corresponding to the broadcast message having the signal strength satisfying a condition is a standby base station, and the condition includes whether the signal strength is greater than a threshold.
